(19) United States
(12) Patent Application Publication
(10) Pub. No.: US 2010/0095868 A1
(43) Pub. Date: Apr. 22, 2010

(54) PEARLESCENT PIGMENTS WITH A CROSS-LINKABLE BINDING AGENT COATING, COATING COMPOSITION, METHOD FOR PRODUCING THE COATED PERLESCENT PIGMENTS AND USE THEREOF

(76) Inventors: Günter Kaupp, Neuhaus (DE); Ulrich Schmidt, Hersbruck (DE); Burkhard Schreiber, Hersbruck (DE); Alexander Albrecht, Dormitz (DE)

Correspondence Address: OSTROLENK FABER GERB & SOFFEN, 1180 AVENUE OF THE AMERICAS, NEW YORK, NY, 100368403, US

(21) Appl. No.: 11/993,867

(22) PCT Filed: Jun. 23, 2006
(86) PCT No.: PCT/EP06/06069

§ 371 Date: Feb. 14, 2008

(30) Foreign Application Priority Data
Jun. 24, 2005 (DE) 10 2005 029 772.2
Jul. 8, 2005 (DE) 10 2005 032 346.4

(51) Int. Cl. C09C 1/00; B05D 7/00; C04B 14/20; C09C 1/02; C04B 14/04; C09C 1/34; C09C 1/04; C09C 1/36; C09C 1/22

(52) U.S. Cl. 106/417; 427/212; 427/221; 427/214; 106/499; 106/469; 106/483; 106/489; 106/454; 106/431; 106/447; 106/460; 106/494

(57) ABSTRACT

The invention relates to coated pearlescent pigments, whereby the coating covers the pearlescent pigments and comprises uncured, however, chemically cross-linkable and/or oligomeric and/or polymeric binding agents that can be cross-linked by heat, IR radiation, UV radiation and/or electron rays. The invention also relates to a method for producing the coated pearlescent pigments and to the use thereof. The invention additionally relates to a coating composition and to a coated article.

The present invention relates to the provision of coated pearlescent pigments, to a coating composition, to a method for the production of the coated pearlescent pigments, to the use thereof, and to a coated article.

Enamels and paints containing pearlescent pigments are suitable for the application of attractive coats of enamel or paint to articles, such as car bodies, façade elements, etc. An efficient type of paint application involves the use of powder paint.

Powder paints are solvent-free paint systems, which are applied by electrostatic methods to the article to be painted. The absence of solvents in powder-paint systems makes the latter very compatible with the environment and as such they are very advantageous.

A few experiments have already been conducted in the prior art with a view to using pearlescent pigments in powder-paint technology.

DE 197 07 051 A1 discloses a method for the production of powder paints containing gloss pigments. In this case, conventional powder-paint components and at least one gloss pigment are placed in a tank equipped with a mixing element and are then mixed with a supercritical fluid. This mixture is then transferred through nozzles into a second tank, after which the supercritical fluid is removed. This method is very cost-intensive due to the high technical effort required for handling the supercritical fluid (high pressure, possibly with cooling). Furthermore, the particles of the gloss pigments agglomerate, and this has a negative influence on the attractiveness of said gloss pigments used in the powder paints.

U.S. Pat. No. 5,824,144 discloses a pearlescent pigment provided with an adhesive surface coating with a view to preventing segregation between the pearlescent pigment and the powder paint. The adhesive surface coating can consist of a polymer, melamine resins being preferred. The adhesive surface coating may be applied to the pearlescent pigments by, say, spray drying. However, the use of adhesive polymers on the pearlescent pigments can detrimentally result in the formation of agglomerates of pearlescent pigment, which in turn can lead to flaws in the powder paint coatings.

DE 100 58 860 A1 discloses a curable powder paint, which is produced by spraying particles of, say, effect pigments, onto powder paint binder particles. The particles are sprayed under conditions that enable the pearlescent pigments to adhere to the surface of the powder paint binder particles. Since the pearlescent pigments are attached to the binder particles only superficially and sometimes only by spot attachment, the pearlescent pigments readily separate from the binder particles, thus causing segregation problems. This in turn results in a change in the relative ratio of the binder to the pearlescent pigments in the powder-paint coating. One of the consequences of this is that the excess powder paint arising during one application cannot be recycled without the occurrence of quality losses in the powder paint coating produced in the next application of powder paint.

DE 100 47 622 A1 discloses a method for the production of polymer-coated pigment particles by precipitation. The polymer is initially dissolved in a suitable first solvent and the pigment particles are dispersed in the solution. Then a solvent is added in which the polymer is insoluble or only poorly soluble. The polymer thus precipitates to encapsulate the pigment particles. The polymer-coated pigments are used in printing. In order to enable fixation of the print, a binder has to be subsequently added, which is then cured.

DE 102 52 007 A1 describes laser-markable pigments consisting of an absorber coated with a marker. Effect pigments can be used as absorbers, while an intrinsically laser-markable polymer can be used as the marker. The laser-markable polymers are fully polymerized and can no longer be subsequently cured.

DE 103 44 660 A1 discloses “encapsulated” pigments, which consist of a core provided with an outer water-soluble shell and comprising organic and/or inorganic pigments. The water-soluble shell consists of a film former. The pigments used can be, say, pearlescent pigments. The term “encapsulated pigments” in the spirit of the teaching of this disclosure refers to granules, pellets, etc. of the pigments. However, these are product forms in which there is indeed a mixture of pigment and binder but in which the pigments need not necessarily be encapsulated by the binder. Another disadvantage is that the core comprises a plurality of pigments. In addition, these pigments are intended for use in aqueous formulations, in which the film former can quickly dissolve.

DE 26 03 211 C2 discloses pulverulent pearlescent pigment compositions, in which solid polymers are applied to pearlescent pigments by means of spray drying for increasing the mechanical stability. The polymers are fully polymerized and have high molecular weights of from about 10⁴ to 10⁶ g/mol.

It is an object of the invention to provide a pearlescent pigment which is suitable for use in a powder paint system for the production of high-quality coatings and which does not suffer from the shortcomings known in the prior art. The present invention particularly aims at solving the problem related to segregation between the powder paint binder and the pearlescent pigments.

Furthermore, the provision of a pearlescent pigment is desired which gives high-quality coatings even when an excess of powder paint arising during application is recycled and reused.

It is further desired to produce such a pearlescent pigment in the form of a dust-free, free-flowing powder and moreover to ensure versatile usability thereof in many powder-paint and wet-paint systems.

It is another object of the invention to provide a cost-effective high-throughput method for the production of such pearlescent pigments. The invention aims at providing a simple method that ensures gentle treatment of the pearlescent pigments.

The object of the invention is achieved by providing a method wherein the coating surrounds the pearlescent pigments and comprises oligomeric and/or polymeric binders that are undercured but chemically cross-linkable and/or cross-linkable by the action of heat, IR radiation, UV radiation, and/or electron beams, and the method comprises the following steps:
a) producing a solution or dispersion of an oligomeric and/or polymeric binder in a solvent, preferably an organic solvent,
b) coating the pearlescent pigments with the binder by
   i) dispersing the pearlescent pigment in the solution or dispersion produced under a) followed by spray-drying this dispersion or
   ii) atomizing the solution or dispersion produced under a) onto pearlescent pigments fluidized in a gas stream, and
c) drying the pearlescent pigments coated with binder in a moving stream of gas.

Preferred developments of the method of the invention are defined in the subclaims 2 to 31.

The object underlying the invention is achieved by the provision of coated pearlescent pigments, wherein the coating surrounds the pearlescent pigments and comprises undercured but chemically cross-linkable oligomeric and/or polymeric binder(s) and/or oligomeric and/or polymeric binder(s) that can be cross-linked by the action of heat, IR radiation, UV radiation, and/or electron beams.

Preferred developments are defined in subclaims 32 to 60.

The object of the invention is further achieved by providing a coating composition that contains the pearlescent pigments according to any one of claims 32 to 60.

Preferred developments of the coating composition are defined in subclaims 62 to 65.

The object of the invention is also achieved by a coated article, the article being coated with pearlescent pigments according to any one of claims 32 to 60 or with a coating composition according to any one of claims 62 to 65.

The object of the invention is finally achieved by the use of a pearlescent pigment according to any one of claims 32 to 60 in paints, enamels, powder paints, printing inks, plastics, and cosmetic formulations such as nail varnish.

The coated article is preferably an article that is exposed to environmental conditions, for example, natural weather conditions. This is the case, for example, in a façade component such as a façade tile or a window frame. Since the pearlescent pigments of the invention are surrounded by a binder which combines with the binder in the powder paint during the curing process of an applied powder paint, for example during the baking process, the pearlescent pigments of the invention are completely and securely disposed within and under a protective binder layer and protected from mechanical influences. This helps achieve better rub resistance.

The pearlescent pigments of the invention are surrounded by a coating containing or consisting of cross-linkable binders in their oligomeric and/or polymeric starting form. After the pearlescent pigment has been enveloped, the binders, depending on their chemical nature, can polymerize under the action of heat, IR radiation, UV radiation and/or electron beams or by reaction with a suitable curing agent, thus embedding the pearlescent pigments in a polymeric film. The complete envelopment of the pearlescent pigments leads to their much improved rub resistance.

It has been found, very surprisingly, that the pearlescent pigments of the invention exist in a non-agglomerated form. Since the pearlescent pigments of the invention exist as non-agglomerated pigment particles, they produce a high-quality coating when used in powder paints. It is characteristic of the coated pearlescent pigments produced using the method of the invention that spherical binder particles are also present in addition to the pearlescent pigments of the invention. The spherical binder particles result from secondary precipitations of the binder during the coating process involved in the method of the invention.

For the purposes of the present invention, the term “binder” is to be understood to mean the definition specified in DIN 55 945. That is to say, the binder comprises both film former and non-volatile additives such as plasticizers and desiccants.

The binders usually exist in the form of oligomers and/or polymers of low molecular weight. The molecular weight preferably ranges from 200 g/mol to 10,000 g/mol, more preferably from 300 g/mol to 9000 g/mol and most preferably from 500 g/mol to 8,000 g/mol. The low molecular weights of the oligomers and/or polymers used serve to achieve specific viscosities, which are not possible when use is made of monomer-dissolved components nor when using high-molecular components (see P. Nanetti, Coatings Compendien “Lackrohstoffkunde” page 17 et seq., Vincentz Verlag 2000).

Curing agents usually exist in monomeric form. The binders, which initially exist in a thermoplastic form, and an optionally used curing agent react with each other under suitable conditions, such as elevated temperature, to form a duromer. Polymerizations can occur at this point. Polyconcondensation or polyadditions can also occur if curing agents are used.

This makes a great difference between the coating of the pearlescent pigments of the invention and the polymer coatings existing in the prior art. The binders are still curable or polymerizable after the pearlescent pigments have been coated. The binders may undergo slight incipient polymerization during the process of coating the pearlescent pigments and evaporation of the solvent but they are not fully cured. By contrast, the hitherto known plastics coatings on pearlescent pigments are formed from monomers, which react almost completely to form a polymeric film on the pigment surface. These predominantly cured polymers are no longer reactive.

The pearlescent pigments of the invention therefore exhibit a reactive binder coating, which specifically enables reaction thereof with the binder of, say, a paint or printing ink, following application of the pearlescent pigment of the invention.

The at least one binder is preferably selected from the group consisting of polyester resins, epoxy resins, polyurethane resins, UV-curing systems, acrylates, and mixtures thereof.

The polyester resins used are preferably saturated polyester resins containing OH-groups and having an OH-number of from 15 to 350 mg KOH/g, preferably from 30 to 150 mg KOH/g and more preferably from 40 to 120 mg KOH/g. An example of a typical resin is Crylcoat 2872-0 supplied by Cytec, USA.

Furthermore, saturated polyester resins containing carboxyl groups and having an acid number of from 15 to 120 mg KOH/g and preferably from 20 to 70 mg KOH/g are preferably used. Typical resins are Crylcoat 1540-0 and Crylcoat 4432-4 supplied by Cytec, USA, www.cytec.com and Uralac P2200 supplied by DSM, Netherlands, www.dsm.com. These resins can be optimized in combination with the appropriate curing agent both with regard to the corrosion resistance required in external applications and also to less critical internal applications. Mixtures of the polyester resins containing OH-groups and polyester resins containing carboxyl groups can also be used. The polyester resins used are preferably polyester binders normally used in powder paints.

The hydroxide number can in each case be determined according to EN ISO 4629 and the acid number according to DIN EN ISO 2114.

The epoxy resins are preferably selected from the group containing more than one epoxy group, and preferably have an epoxy equivalent weight (EEW) of from 175 to 6,000 and more preferably from 400 to 2,500.

The polyurethane resins are preferably selected from the group consisting of OH-functional polyester resins or polyacrylate resins with blocked and/or free polyisocyanates, and mixtures thereof.

The UV-curing systems are preferably compounds having monounsaturated and/or polyunsaturated double bonds.

Furthermore, the binder(s) are preferably selected from the group of binders that are conventionally used in powder paints, including
so-called dual-cure resins of the trade name Uranox supplied by DSM, Netherlands
epoxy resins that are preferably typically used in powder paints and have an epoxy equivalent weight of preferably from 175 to 6,000 and more preferably from 450 to 4,000
acrylate resins that are preferably typically used in powder paints (e.g. those supplied by Mitsui, Japan)
UV-curing resins that are preferably typically used in powder, paints, for example UVECOAT 3001 supplied by Cytec, USA.

The curing agents are preferably selected from the group consisting of hydroxyalkylamine-containing compounds, glycidyl group-containing compounds, epoxy group-containing compounds, triglycidyl isocyanurates, and mixtures thereof.

Furthermore, preferably those compounds are used as curing agents that are chemical antipodes to the corresponding reactive groups of the resin. For example, these may include:
compounds from the group of the β-hydroxyalkylamides, such as Primid XL 552, supplied by Ems-Primid, Switzerland
compounds based on glycidyl functions such as triglycidyl isocyanurate (known by the trade name TGIC), such as Araldit PT 810 or Araldit PT 910, supplied by Huntsman, Switzerland
compounds based on capped and free isocyanates such as Vestagon BF 1540, supplied by Degussa, or Vestagon BF 1530
epoxy curing agents based on organic salts such as Vestagon B31, supplied by Degussa, Germany.
curing agents subjected to excitation by radiation, such as IRGACURE 2959 and IRGACURE 819, supplied by Ciba Spezialitätenchemie, Switzerland.
resins that have complementary groups to the above-mentioned resins.

The pearlescent pigments coated according to the invention preferably exist in the form of a dust-free, free-flowing powder, which can optionally also be worked to a paste in solvents, for example, organic solvents and/or water. The pearlescent pigments of the invention are thus characterized by high flexibility in use.

In the case of powder paint applications, the pearlescent-pigmented powder paint shows excellent recyclability. That portion of the powder paint containing pearlescent pigments of the invention and not cured on a substrate can be advantageously recycled and sprayed in the next application of powder paint. The encapsulation of the pearlescent pigments with the binder prevents the pearlescent pigment from separating from the binder. Thus, there is also no substantial change, and preferably no change at all, in the relative quantity ratios of pearlescent pigment to binder. The application of recycled powder paint thus results in high-quality coatings that do not differ from coatings obtained when the powder paint of the invention is applied for the first time.

The powder paint and the coating on the pearlescent pigments preferably contain at least a similar, or the same, binder.

The binders used for encapsulating the pearlescent pigment are preferably the same as those used as binders in a powder paint. Such binders of the invention are thus suitable for use as a masterbatch or concentrate for the production of a powder paint containing pearlescent pigments. The use of the same binders in the coating on the pearlescent pigments of the invention as those present in the powder paint results, after application and curing of the powder paint, in the formation of a homogeneous layer of paint, in which the pearlescent pigments are chemically attached. Such coats of paint have an extremely attractive appearance and are very resistant to mechanical stresses.

The content of binder in the pearlescent pigments of the invention is preferably from 20 to 85% by weight, more preferably from 52 to 75% by weight and most preferably from 55 to 60% by weight, always based on the total weight of the coated pearlescent pigment.

The binders preferably do not, or not substantially, polymerize during or after the process of coating the pearlescent pigments. Polymerization of the binder surrounding the pearlescent pigments preferably takes place only when baking the finished paint following application of the pearlescent pigments of the invention in the application medium. In this case, polymerization is induced thermally.

However, with free-radically polymerizing binders, curing can be effected by means of UV radiation or IR radiation. In this case, both the binder in the paint and the binder in the pigment coating can polymerize.

One of the significant advantages of the pearlescent pigments of the invention is the much better binding of the pearlescent pigments to the binder in the paint or printing ink. This improved binding effect is ensured particularly if the binder used as the pigment coating is the same as that used in the application medium.

In powder paint applications, higher pigmentation levels of pearlescent pigments can be achieved than hitherto possible, without the occurrence of segregation between the pearlescent pigment and powder paint occurring. Such segregation gives rise to so-called “spits” in the coat of powder paint and impairs the recyclability of the pearlescent-pigmented powder paint. Powder paints having higher levels of pigmentation have a stronger pearlescent effect and better coverage.

Preferably, standard commercially available pearlescent pigments based on platelet-like, transparent or semitransparent substrates can be used as pearlescent pigments.

The pearlescent pigments preferably comprise a substrate selected from the group consisting of mica, talc, sericite, kaolin as well as platelets of SiO₂, glass, graphite or Al₂O₃, and mixtures thereof.

These substrates of the pearlescent pigments are preferably coated with one or more layers selected from the group consisting of metal oxides, metal hydroxides, metal oxyhydrates, metal suboxides, metal sulfides, metal fluorides, metal chalcogenides, metal nitrides, metal sulfides, metal carbides, and mixtures thereof.

A coating containing metal oxides is particularly preferred. Thus, for example, the substrates of the pearlescent pigments are coated with one or more metal oxides selected from the group consisting of TiO₂, Fe₂O₃, Fe₃O₄, TiFe₂O₅, ZnO, SnO₂, CoO, CO₃O₄, ZrO₂, Cr₂O₃ VO₂, V₂O₃, (Sn,Sb)O₂, and mixtures thereof. However, the corresponding hydroxides or oxide hydrates can also be applied as coatings. Of course, mixed layers comprising the aforementioned oxides and the corresponding hydroxides and/or oxide hydrates can be applied, if desired.

TiO₂ and Fe₂O₃ are particularly preferred, with the TiO₂ being in anatase and/or rutile modification.

In other embodiments, the substrates of the pearlescent pigments are coated with a plurality of layers containing or consisting of metal oxide, metal hydroxide, metal suboxide, and/or metal oxide hydrate.

The metal oxides, metal suboxides, metal hydroxides, and/or metal oxide hydrates can be intermixed in one and the same layer or they can be discretely present in successive layers.

In a preferred variant, this multi-layer structure containing or comprising metal oxide, metal hydroxide, metal suboxide, and/or metal oxide hydrate has an alternating sequence of layers. The substrate can first of all be coated by at least one high-refractive-index layer, followed by at least one low-refractive-index layer and then by at least one high-refractive-index layer. In such an alternating sequence of layers, there are preferably one high-refractive-index layer, one low-refractive-index layer, one high-refractive-index layer, and so on, directly following each other. Alternatively, however, it is possible to consecutively arrange a packet of layers composed of two or more high-refractive-index layers, followed by a packet of layers comprising two or more low-refractive-index layers, and then by another packet of layers composed of two or more high-refractive-index layers, and so on, on the substrate.

The high-refractive-index layer(s) or low-refractive-index layer(s) can each contain or consist of metal oxide, metal hydroxide, metal suboxide, and/or metal oxide hydrate.

Pearlescent pigments having the alternating sequence of layers described above have more intensive interference effects.

The high-refractive-index metal oxide is preferably selected from the group consisting of TiO₂, Fe₂O₃, Fe₃O₄, TiFe₂O₅, ZnO, SnO₂, CoO, CO₃O₄, ZrO₂, Cr₂O₃VO₂, V₂O₃, (Sn,Sb)O₂, and mixtures thereof. The low-refractive-index metal oxide is preferably selected from the group consisting of SiO₂, Al₂O₃, and mixtures thereof.

In a special embodiment, the pearlescent pigments to be coated have glass flakes as the substrate and have the following layer structures, for example:

| | | | | | |
|---|---|---|---|---|---|
| glass flakes + | TiO₂ + | SiO₂ + | TiO₂ | | |
| glass flakes + | TiO₂ + | SiO₂ + | Fe₂O₃ | | |
| glass flakes + | TiO₂ + | SiO₂ + | TiO₂ /Fe₂O₃ | | |
| glass flakes + | TiO₂ + | SiO₂ + | (Sn,Sb)O₂ | | |
| glass flakes + | (Sn,Sb)O₂ + | SiO₂ + | TiO₂ | | |
| glass flakes + | Fe₂O₃ + | SiO₂ + | (Sn,Sb)O₂ | | |
| glass flakes + | TiO₂/ | SiO₂ + | TiO₂/Fe₂O₃ | | |
| | Fe₂O₃ + | | | | |
| glass flakes + | TiO₂ + | SiO₂ + | MoS₂ | | |
| glass flakes + | TiO₂ + | SiO₂ + | Cr₂O₃ | | |
| glass flakes + | Cr₂O₃ + | SiO₂ + | TiO₂ | | |
| glass flakes + | Fe₂O₃ + | SiO₂ + | TiO₂ | | |
| glass flakes + | TiO₂ + | Al₂O₃ + | TiO₂ | | |
| glass flakes + | Fe₂TiO₅ + | SiO₂ + | TiO₂ | | |
| glass flakes + | TiO₂ + | SiO₂ + | Fe₂TiO₅/TiO₂ | | |
| glass flakes + | TiO₂ | SiO₂ + | TiO₂ suboxide | | |
| | suboxide + | | | | |
| glass flakes + | TiO₂ + | SiO₂ + | TiO₂ + | SiO₂ + | TiO₂ |

In another embodiment, the pearlescent pigments consist of glass flakes coated on both sides with semitransparent metal layers.

These semitransparent metal layers are preferably selected from the group consisting of silver, aluminum, chromium, nickel, gold, platinum, palladium, copper, zinc, and mixtures and alloys thereof.

Furthermore, the pearlescent pigment substrates coated with one or more metal oxide layers can be additionally enveloped by at least one protective layer of metal oxide, metal hydroxide, and/or metal oxide hydrate. The metals are preferably selected from the group consisting of silicon, aluminum, cerium, manganese, zirconium, chromium, and mixtures thereof. Such pearlescent pigments are usually weather-resistant.

Finally, the pearlescent pigments may consist of a single platelet-like material selected from the group consisting of bismuth oxychloride, TiO₂, and Fe₂O₃.

The pearlescent pigments are preferably selected from the group consisting of bismuth oxychloride pigments, metal oxide-coated mica, metal oxide-coated SiO₂ platelets, metal oxide-coated Al₂O₃ platelets, metal oxide-coated glass platelets, and mixtures thereof.

For example, the pearlescent pigments supplied by Merck KGaA, Darmstadt, Germany under the trade names Iriodin®, Florapearl®, Solarflair®, Lazerflair™, Biflair®, Minatec®, Miraval®, Xirallic®, and Colorstream®, and those supplied by Engelhard, USA under the trade names Mearlin® and Exterior Mearlin® and the pearlescent pigments supplied by Eckart under the trade names Prestige® and Phoenix® can be used.

The pearlescent pigments as such can be uncoated. However, they may be pre-coated, i.e., they can have additional protective layers. These protective layers can be barrier layers such as SiO₂ or polymerized, highly cross-linked polymer layers.

In another development of the invention, the coating may also contain other additives and/or auxiliaries conventionally used in paints and powder paints such that the pearlescent pigments of the invention have customized application properties in the application medium.

In a development of the invention, such additives and/or auxiliaries can comprise organic and/or inorganic colored pigments and dyes. Dyed pearlescent pigments are thus available. It is thus possible to produce, in particular, colored effect powder paints showing high mechanical stability, as follows:

(a) Colored pigments
i) Organic colored pigments
   Suitable organic colored pigments include commercially available pigments of the classes monoazo, bisazo, anthraquinone, phthalocyanine-blue, phthalocyanine-green, perylene, perinone pigments, indigo, thioindigo, indolinone, isoindolinone pigments, quinacridone, pyrrolopyrrolidone, dioxazine pigments and metal complex pigments such as, for example, copper azomethine yellow and other classes and pigments listed in Herbst/Hunger “Industrielle org. Pigmente”, VCH Verlagsgesellschaft mbH, Weinheim, Germany (1987).
ii) Inorganic colored pigments
   Suitable inorganic colored pigments include iron oxide pigments, lead chromate pigments, chromium oxide pigments, ultramarine pigments, complex inorganic colored pigments, iron blue pigments, cadmium pigments, bismuth vanadate pigments, cerium sulfide pigments and commercially available titanium dioxide pigments and zinc sulfide white pigments, and other classes and pigments listed in “Aktuelle anorg. Buntpigmente” Vincentz-Verlag, Hartmut Endriss.

### (b) Dyes

Use is made of dyes that are migration-stable under the conditions of the application, such as heavy metal salts complexed with azo ligands, and organometallic compounds containing at least one azo and/or chromophore group and are soluble in the medium used, for example, Solvent Yellow 79, Solvent Red 8, Solvent Blue 45, and Solvent Black 45, as supplied by Clariant, Basel, Switzerland.

Preferably such additives and auxiliaries are selected from the group consisting of additives such as viscosity-decreasing additives, slip agents, flow-control agents and fillers, degassing agents, film-forming agents, flame retardants, adhesion-promoting agents, light stabilizers, flatting agents, photoinitiators, polymerization inhibitors, polymerization initiators, scavengers, anti-caking agents, radiation-curing reactive diluents, thermally cross-linkable reactive diluents, UV absorbers, cross-linking catalysts, waxes, and mixtures thereof.

Preferably, polyester-modified polydimethylsiloxanes are used as viscosity-decreasing additives. Examples thereof are BYK 333, BYK 306, BYK 341, and BYK 310 supplied by Byk-Chemie, Wesel, Germany.

In a development of the invention, it is likewise possible to pre-coat the pearlescent pigment with a substance that improves the adhesion between the pearlescent pigment surface and the binder coating. Such substance can be, say, functionalized silanes, functionalized polymers, and organophosphorus compounds such as phosphate esters. These substances can also be applied over the additional coating.

The pearlescent pigments of the invention can be used alone or together with other pigments in coating compositions, a masterbatch, or a powder paint.

In accordance with a preferred embodiment, the pearlescent pigments of the invention can be used together with corrosion-stabilized metal pigments or metal effect pigments. Pearlescent pigments cannot corrode and are therefore suitable for coatings exposed to corrosive conditions or natural weathering. Mixtures consisting of the pearlescent pigments of the invention and corrosion-stabilized metal effect pigments can be used in powder paint systems to be used for the powder-paint coating of, say, façade components, car bodies, vehicle frames, etc. In addition to the coated pearlescent pigments of the invention, it is possible to use those pigments in the powder paint which are disclosed in DE 103 61 437.0, incorporated herein by reference.

It has been found, surprisingly, that the pigments surrounded by binders in accordance with the invention can also be used as masterbatches for powder paints. In the case of a masterbatch, the content of binders is preferably from 50 to 85% by weight, more preferably from 55 to 80% by weight and most preferably from 60 to 75% by weight.

Masterbatches are normally used in plastics. Here, a masterbatch is a highly pigmented plastic, which is added to the plastic medium in an extruder.

In powder coating technology, a pearlescent pigment produced using a conventional bonding process represents a type of preform of a masterbatch. The term “bonding process” refers to a mixing process of powder paint and pearlescent pigment in which the particles of pearlescent pigment are made to bind physically to the particles of powder paint by heating the mixture to a temperature approaching the glass transition temperature of the powder paint. In the bonding process, the pearlescent pigments thus adhere to the surface of the powder paint particles. However, only pigmentation levels of approx. not more than 6 to 8% by weight and in practice of from 5 to 6% by weight are achievable in the case of pearlescent pigments.

In the case of the pearlescent pigments coated in accordance with the invention, it is possible to achieve substantially higher concentrations of pearlescent pigments, thereby providing a genuine masterbatch. This holds true particularly if the pearlescent pigment is coated with the same binder system as that in which it will be incorporated and is subsequently processed, for example, in a powder paint.

In the present invention, it is possible, to great advantage, to provide a masterbatch or a coating composition having a pearlescent pigment content of preferably from 0.5 to 15% by weight, more preferably from 2 to 12% by weight and most preferably from 6 to 10% by weight, always based on the total weight of the masterbatch or the coating composition.

The high pigmentation level of the masterbatch and coating composition made possible by the present invention opens up completely new possibilities. For example, the use of highly pigmented or highly concentrated masterbatches is a great advantage during transport. Due to the higher concentration of the masterbatch, smaller quantities thereof need be used and thus transported, whilst retaining the same final concentration, for example, in a powder paint.

In a coating composition, the higher concentration of pearlescent pigment allows for improved coverage with pearlescent pigments on a relevant substrate, which is not possible with conventional powder paint systems.

The statements made with regard to the pearlescent pigments or the coating composition of the invention apply equally to the description of the method of the invention.

The pearlescent pigments are insoluble in the organic solvent and form a dispersion with the solvent and any compounds dissolved therein. The binders and any additives and/or auxiliaries optionally used, for example curing agents, are soluble in, preferably, organic solvents, but if they are insoluble therein, they can form a dispersion therein.

Preferably, other additives and/or auxiliaries are added to the oligomeric and/or polymeric binders dissolved or dispersed in the solvent before the solution or dispersion is brought into contact with the pearlescent pigments.

The additives and/or auxiliaries preferably used have already been defined above. When incorporating the additives and/or auxiliaries into a solution or dispersion of polymeric or oligomeric binders, there is the advantage that a uniform distribution of the additives and/or auxiliaries is achieved in the coating applied to the pearlescent pigments.

The additives and/or auxiliaries can include, for example, curing agents, photo initiators, and/or polymerization initiators. The additives and/or auxiliaries have already been explained above in detail.

Water, organic solvents or aqueous organic solvents can be used as solvents. It is preferred to use organic solvents and particularly preferred to use highly volatile organic solvents, such as, for example, acetone and/or ethyl acetate.

Removal of the solvent, i.e., drying of the coated pearlescent pigments preferably takes place with simultaneous or subsequent fluidization of the coated pearlescent pigments.

Fluidization of the coated pearlescent pigments reliably prevents aggregation or agglomeration of the pearlescent pigments. Since the pearlescent pigments in an applied coat of paint virtually act as a plurality of small optically active elements, agglomeration of the pearlescent pigments should be avoided in order to prevent impairment of the pearlescent effect of the coating.

Preferably, in a first variant of the method of the invention, the steps (bi) and (c) are combined by effecting spraying of the coated pearlescent pigments and the removal of the solvent by spray drying.

Spray drying is a particularly economical drying method, which at the same time ensures high throughput. Spray drying can be used in both batch operation and continuous operation.

Spray drying causes atomization of the dispersion in an enclosed chamber using a suitable spraying pressure. The spraying pressure is adjusted according to constraints such as the solids content, the viscosity of the dispersion to be sprayed, the temperature in the reactor, the type of solvent, etc. and can be easily determined by those skilled in the art. The dispersion is preferably atomized in a gas stream, for example, air or nitrogen. The droplets formed cause, due to the sharp increase in surface area, a high degree of evaporation of the solvent. This evaporation of the solvent can be improved further by increasing the temperature of the carrier air. The temperature is chosen such that there is no substantial polymerization or curing of the reactive coating on the pearlescent pigments.

During spray drying, the dispersion can be atomized by means of centrifugal atomizers, such as atomizer disks or atomizer wheels, pressure nozzles or two-fluid atomizing nozzles. The gas stream can flow through the equipment either co-currently or counter-currently. When spray drying is performed in a mixed stream, the nozzles are disposed in the lower part of the drying tower. Spraying takes place upwardly in a fountain-like manner. The separation of the product from the gas stream takes place below the spray tower, by means of a cyclone and a filter. Furthermore, a combined procedure, so-called fluidized spray drying, can be used for drying the suspension to be sprayed. This method combines the advantages of spray drying fine droplets with those of fluidized bed drying. Of course, other methods of spray drying can be used, if desired.

According to another preferred embodiment, the steps (bii) and (c) are combined by performing the coating and drying processes of the pearlescent pigments in a fluidized bed, the oligomeric and/or polymeric binders dissolved or dispersed in the solvent being sprayed and the solvent being removed during fluidization in the fluidized bed.

This variant of the method corresponds to fluidized bed coating. The pigment is placed in a closed spray drying apparatus and fluidized by blowing in compressed air or pressurized nitrogen. The quantity of compressed air or pressurized nitrogen is selected such that the resulting surface is smooth and not turbulent. The binder solution or binder dispersion is then conveyed through a nozzle and sprayed into the moving fluidized bed. The solvent can then be removed as in the first variant of the method, for example, by applying heat, so that the pearlescent pigment of the invention is dried.

The pigment/binder/solvent dispersions for such spray drying or the binder solution or binder dispersion for said fluidized bed coating can be produced with, say, the following organic solvents: alcohols, ethers, esters, ketones and also aliphatic and aromatic hydrocarbons having a boiling point below 130° C. Acetone and ethyl acetate are particularly preferred. In addition, mixtures of the aforementioned organic solvents can be used. Water and mixtures of water and solvent can likewise be used.

The dispersion is preferably sufficiently liquid to be sprayed easily through a nozzle. The solvent content of the dispersion is preferably from 50 to 97% by weight, more preferably from 50 to 85% by weight and most preferably from 50 to 75% by weight, always based on the total weight of the dispersion.

The pressure under which the compressed air or nitrogen is admitted into the apparatus is preferably from 1 to 5 bar, and more preferably from 2 to 4 bar.

The temperature for evaporating the solvent substantially depends on the nature of the solvent. Preferred temperatures range from 0 to 130° C. and more preferably from 20 to 80° C.

The temperature is preferably chosen such that the solvent evaporates well without the binder coating polymerizing to any substantial degree, and preferably not at all. However, slight polymerization of the binder is permissible and is insignificant as long as the binder is subsequently sufficiently reactive.

The pearlescent pigment of the invention produced according to the two variants of the present method is a dust-free, free-flowing powder having a grain size d₅₀ of from 2 to 190 μm and preferably from 5 to 100 μm. It is thus not composed of granules. Granules have a size in the order of magnitude of millimeters.

The pearlescent pigment powder of the invention can be mixed with a suitable liquid phase, preferably a solvent; such that it can exist in the form of a paste. In this case, the pigment content of the paste is preferably from 30 to 80% by weight, based on the total weight of the paste.

Preferably water or organic solvents such as aliphatic hydrocarbons (petroleum spirit), aromatic hydrocarbons (solvent naphtha), alcohols, esters, ketones, aldehydes, ethers, or mixtures thereof are used as solvents for working the pearlescent pigment to a paste. However, the solvents used should not be such as to re-separate the binder from the pearlescent pigment.

The pearlescent pigment coated in accordance with the invention is preferably used in the production of paints, enamels, powder paints, printing inks, plastics, and cosmetics.

The following examples and figures describe the invention without restricting it.

### EXAMPLE 1

Of a saturated polyester having an acid number of 70 (Crylcoat 1540-0 (supplied by Cytec, USA) and 125 g of an epoxy resin having an epoxy equivalent weight of 750 (Araldit GT 6063 ES, supplied by Huntsman, Switzerland) were dissolved in 1800 g of acetone, and 250 g of PHOENIX PX 1001 (d₅₀=21 μm) (supplied by Eckert, Fuerth, Germany) were added with stirring. 2300 g of the dispersion were sprayed into a spray drier at a rate of 30 g/min using a spraying pressure of 2.5 bar in a warm stream of air having a temperature of 55° C. A yield of 483 g of pigment polymer composition was obtained after drying.

This pigment polymer composition is mixed homogeneously with a commercially available powder paint (e.g. Polyester Primidsystem supplied by DuPont, Essenbach, Germany) in a ratio of 1:9 (a, 5% pigment content) and 1:4 (b, 10% pigment content).

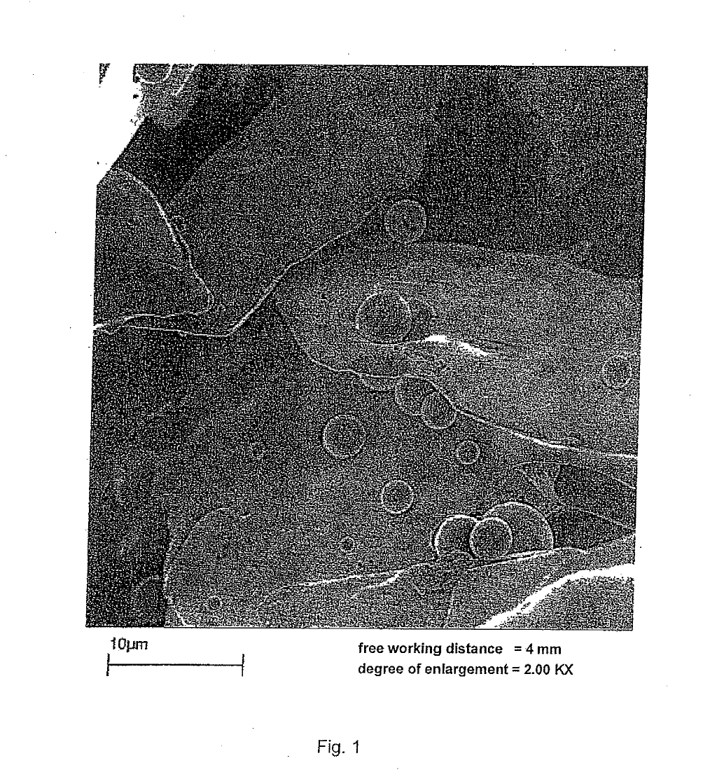

FIG. 1 shows a scanning electron micrograph of the pearlescent pigment coated in accordance with Example 1 of the invention. FIG. 1 clearly shows that the pearlescent pigments coated in accordance with the invention are present, surprisingly, in a non-agglomerated form. Furthermore, spherical binder particles can be seen, which result from secondary precipitations of binder. The presence of spherical binder particles beside the pearlescent pigments coated in accordance with the invention is characteristic of the pearlescent pigments of the invention.

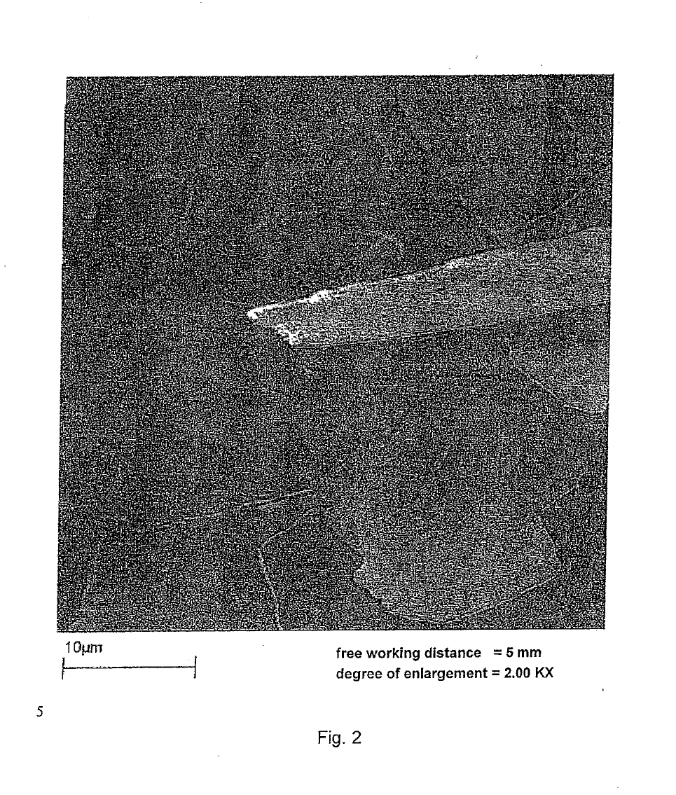

FIG. 2 shows the uncoated starting pigment.

Comparison of these two figures shows that the pigments of the invention are completely enveloped by the binder coating.

### EXAMPLE 2

125 g of a saturated polyester having an acid number of 70 (Crylcoat 1540-0 (supplied by Cytec, USA) and 125 g of an epoxy resin having an epoxy equivalent weight of 750 (Araldit GT 6063 ES supplied by Huntsman, Switzerland) were dissolved in 1800 g of acetone, and 250 g of PHOENIX XT 1001 (d₅₀=21 μm) [Chromium(III)-hydroxide-stabilized pearlescent pigment for external applications, supplied by Eckart, Fuerth, Germany] were added with stirring. 2300 g of the dispersion were sprayed into a spray drier at a rate of 30 g/min using a spraying pressure of 2.5 bar in a warm stream of air having a temperature of 55° C. A yield of 491 g of pigment polymer composition was obtained after drying.

This pigment polymer composition is mixed homogeneously with a commercially available powder paint (e.g. Polyester Primidsystem supplied by DuPont, Essenbach, Germany) in a ratio of 1:9 (a, 5% pigment content) and 1:4 (b, 10% pigment content).

### EXAMPLE 3

237.5 g of a saturated polyester having an acid number of 70 (Crylcoat 1540-0 (supplied by Cytec, USA)) and 237.5 g of an epoxy resin having an epoxy equivalent weight of 750 (Araldit GT 6063 ES supplied by Huntsman, Switzerland) were dissolved in 1800 g of acetone, and 25 g of PHOENIX XT 1001 (d₅₀=21 μm) [Chromium(III)-hydroxide-stabilized pearlescent pigment for external applications, supplied by Eckart, Fuerth, Germany] were added with stirring. 2300 g of the dispersion were sprayed into a spray drier at a rate of 30 g/min using a spraying pressure of 2.5 bar in a warm stream of air having a temperature of 55° C. A yield of 478 g of pigment/polymer composition was obtained after drying.

In commonly used powder painting procedures, this pigment/polymer composition is applied directly without additional treatment.

### EXAMPLE 4

12.5 g of a saturated polyester having an acid number of 70 (Crylcoat 1540-0 (supplied by Cytec, USA) and 12.5 g of an epoxy resin having an epoxy equivalent weight of 750 (Araldit GT 6063 ES supplied by Huntsman, Switzerland) were dissolved in 1800 g of acetone and 475 g of PHOENIX XT 1001 (d₅₀=21 μm) [Chromium(III)-hydroxide-stabilized pearlescent pigment for external applications, supplied by Eckert, Fuerth, Germany] were added with stirring. 2300 g of the dispersion was sprayed into a spray drier at a rate of 30 g/min using a spraying pressure of 2.5 bar in a warm stream of air having a temperature of 55° C. A yield of 483 g of pigment/polymer composition was obtained after drying.

This pigment/polymer composition is mixed homogeneously with a commercially available powder paint (e.g. Polyester Primidsystem supplied by DuPont, Essenbach, Germany) in a ratio of 1:18 (a, 5% pigment content) and 1:9 (b, 9.5% pigment content).

### COMPARATIVE EXAMPLE 5

### Dry-Blend Method

Starting from PHOENIX XT 1001 (d₅₀=21 μm) (supplied by Eckert, Fuerth, Germany) and a commercially available powder paint (e.g. Polyester-Primidsystem supplied by DuPont, Essenbach, Germany), there is produced a dry blend of powder paint capable of application to a substrate. The pearlescent pigments PHOENIX XT and powder paint particles are present side by side in the dry blend without being bonded to each other. The pigmentation level is 5% (Comparative Example 1a) and 10% (Comparative Example 1b)

### COMPARATIVE EXAMPLE 6

### Bonding Method

Starting from PHOENIX XT 1001 (d₅₀=21 μm) (supplied by Eckert, Fuerth, Germany) and a commercially available powder paint (e.g. Polyester Primidsystem supplied by DuPont, Essenbach, Germany), a bonded composition of powder paint capable of application to a substrate is produced using a conventional bonding process (e.g. STARBONDING, ECKART GmbH & Co. KG). The pigmentation level is 5% (Comparative Example 6a), 7.5% (Comparative Example 6b) and 10% (Comparative Example 2c).

The powder paints were applied electrostatically, baked, and assessed visually to examine their optical and application-specific properties. The powder paints produced in accordance with the method of the invention display a uniform spray pattern and an excellent pearlescent effect with a pronounced depth effect even at pigmentation levels of up to 10%. Another advantage is the excellent ability of the pearlescent pigments coated in accordance with the invention to be recycled. While the application of conventional pearlescent pigments (Comparative Example 1) shows that, after cycloning, considerable color shifts are caused by the partial segregation between pigment and powder paint, the pearlescent pigments coated in accordance with the invention show no changes in application even after the powder paint had been passed through the cyclone three times.

Another advantage of the pearlescent pigments coated in accordance with the invention is seen in their improved processing characteristics for powder coating. Due to the greatly varying electrostatic charging behavior of the pearlescent pigment and the powder paint binder, agglomeration takes place in the spray gun. This leads to the emergence of pigment lumps (spits) into the sprayed application. The visual assessment of this lump formation using the grading system specified in DIN 53 230 involves the following grades:

Grade 0: no lump formation
Grade 1: just visually perceptible lump formation
Grade 2: slight lump formation
Grade 3: moderate lump formation
Grade 4: severe lump formation
Grade 5: very severe lump formation

The results have been summarized in the following table:

| | Pigmentation | Gloss | Lump formation |
|---|---|---|---|
| Example | | | |
| 1 a) | 5% | excellent | 0 |
| 1 b) | 10% | good | 1 |
| 2 a) | 5% | excellent | 0 |
| 2 b) | 10% | excellent | 1 |
| 3 | 5% | excellent | 0 |
| 4 a) | 5% | excellent | 0 |
| 4 b) | 9.5% | excellent | 0 |
| Comparative Example | | | |
| 5 a) | 5% | good | 3 |
| 5 b) | 10% | moderate | 5 |
| 6 a) | 5% | excellent | 1 |
| 6 b) | 7.5% | moderate | 4 |
| 6 c) | 10% | moderate | 5 |

The pearlescent pigments surrounded with binders according to the invention can thus be applied, even in a single dry-blend process, with much better results than is the case involving bonded pearlescent pigments.

1. A method for the production of coated pearlescent pigments, wherein the coating surrounds the pearlescent pigments and comprises oligomeric and polymeric binders which are undercured but chemically cross-linkable and cross-linkable by the action of heat, IR radiation, UV radiation and/or electron beams, said method comprising the following steps:
a) producing a solution or dispersion of an oligomeric and/or polymeric binder in a solvent, preferably an organic solvent,
b) coating the pearlescent pigments with the binder by
i) dispersing the pearlescent pigment in the solution or dispersion produced under a) followed by spray-drying this dispersion or
ii) atomizing the solution or dispersion produced under a) onto pearlescent pigments fluidized in a gas stream, and
c) drying the pearlescent pigments coated with binder in a moving stream of gas.

2. The method for the production of coated pearlescent pigments according to claim 1, wherein the particle size d₅₀ of the coated pearlescent pigments ranges from 2 to 190 μm.

3. The method for the production of coated pearlescent pigments according to claim 1, wherein the particle size d₅₀ of said coated pearfescent pigments ranges from 5 to 100 μm.

4. The method according to claim 1, wherein the pearlescent pigments have from 20 to 85% by weight of oligomeric and polymeric binder, based on the total weight of said coated pearlescent pigments.

5. The method according to claim 1, wherein the steps (bi) and (c) are combined by effecting atomization of said coated pearlescent pigments and the removal of the solvent by spray-drying.

6. The process according to claim 1, wherein the steps (bii) and (c) are combined by effecting coating arid drying of said pearlescent pigments in a fluid bed or fluidized bed, the oligomeric and polymeric binder dissolved or dispersed in the solvent being sprayed in, while the solvent is removed during fluidization in the fluid bed or fluidized bed.

7. The process according to claim 1, wherein said pearlescent pigments have a substrate selected from the group consisting of mica, talc, sericite, kaolin and also platelets of SiO₂, glass, graphite, Al₂O₃, and mixtures thereof.

8. The method according to claim 7, wherein said substrates of said pearlescent pigments are coated with one or more layers selected from the group consisting of metal oxides, metal hydroxides, metal oxide hydrates, metal suboxides, metal sulfides, metal fluorides, metal chalcogenides, metal nitrides, metal sulfides, metal carbides, and mixtures thereof.

9. The method according to claim 7, wherein said substrates of said pearlescent pigments are provided with a multilayered lamellar structure comprising layers containing or consisting of metal oxide, metal hydroxide, metal suboxide, and metal oxide hydrate.

10. The method according to claim 7, wherein the substrates of said pearlescent pigments are coated with one or more metal oxide layer(s) selected from the group consisting of TiO₂, Fe₂O₃, Fe₃O₄, TiFe₂O₅, ZnO, SnO₂, CoO, CO₃O₄, ZrO₂, Cr₂O₃, VO₂, V₂O₃, (SnSb)—O₂, and mixtures thereof.

11. The method according to claim 9, wherein said multilayered lamellar structure comprises layers containing or consisting of high-refractive-index and low-refractive-index metal oxide, metal hydroxide, metal suboxide, and/or metal oxide hydrate, which are preferably arranged alternately, wherein the substrate is preferably first covered by at least one high-refractive-index layer, then by at least one low-refractive-index layer and finally by at least one high-refractive-index layer.

12. The method according to claim 11, wherein said high-refractive-index metal oxide is selected from the group consisting of TiO₂, Fe₂O₃, Fe₃O₄, TiFe₂O₅, ZnO, SnO₂, CoO, CO₃O₄, ZrO₂, Cr₂O₃, VO₂, V₂O₃, (SnSb)—O₂, and mixtures thereof, and that said low-refractive-index metal oxide is preferably selected from the group consisting of SiO₂, Al₂O₃, and mixtures thereof.

13. The method according to claim 7, wherein said pearlescent pigments have glass flakes as the substrate and have the following layer structures:

| | | | | | |
|---|---|---|---|---|---|
| glass flakes + | TiO₂ + | SiO₂ + | TiO₂ | | |
| glass flakes + | TiO₂ + | SiO₂ + | Fe₂O₃ | | |
| glass flakes + | TiO₂ + | SiO₂ + | TiO₂ /Fe₂O₃ | | |
| glass flakes + | TiO₂ + | SiO₂ + | (Sn,Sb)O₂ | | |
| glass flakes + | (Sn,Sb)O₂ + | SiO₂ + | TiO₂ | | |
| glass flakes + | Fe₂O₃ + | SiO₂ + | (Sn,Sb)O₂ | | |
| glass flakes + | TiO₂/ | SiO₂ + | TiO₂/Fe₂O₃ | | |
| | Fe₂O₃ | | | | |
| glass flakes + | TiO₂ + | SiO₂ + | MoS₂ | | |
| glass flakes + | TiO₂ + | SiO₂ + | Cr₂O₃ | | |
| glass flakes + | Cr₂O₃ | SiO₂ + | TiO₂ | | |
| glass flakes + | Fe₂O₃ + | SiO₂ + | TiO₂ | | |
| glass flakes + | TiO₂ + | AI₂O₃ + | TiO₂ | | |
| glass flakes + | Fe₂TiO₅ + | SiO₂ + | TiO₂ | | |
| glass flakes + | TiO₂ + | SiO₂ + | Fe₂TiO₅/TiO₂ | | |
| glass flakes + | TiO₂ | SiO₂ + | TiO₂ suboxide | | |
| | suboxide + | | | | |
| glass flakes + | TiO₂ + | SiO₂ + | TiO₂ + | SiO₂ + | TiO₂ |

14. The method for the production of coated pearlescent pigments according to claim 7, wherein said pearlescent pigments consist of glass flakes coated on both sides with semi-transparent metal layers.

15. The method for the production of coated pearlescent pigments according to claim 14, wherein said semi-transparent metal layers are selected from the group consisting of silver, aluminum, chromium, nickel, gold, platinum, palladium, copper, zinc, and mixtures and alloys thereof.

16. The method according to claim 7, wherein the pearlescent pigment substrates coated with one or more metal oxide layer(s) are additionally coated all round with at least one external protective layer of metal oxide, metal hydroxide and metal oxide hydrate, which metals are preferably selected from the group consisting of silicon, aluminum, cerium, manganese, zirconium, chromium, and mixtures thereof.

17. The method for the production of coated pearlescent pigments according to claim 1, wherein said pearlescent pigments consist of a single platelet-like material, which material is selected from the group consisting of bismuth oxychloride, TiO₂ and Fe₂O₃.

18. The method for the production of coated pearlescent pigments according to claim 1, wherein said pearlescent pigments are primed with adhesion promoters for the binder coating, preferably with functionalized silanes, functionalized polymers, and organophosphoric compounds and more preferably with phosphate esters.

19. The method for the production of coated pearlescent pigments according to claim 1, wherein the binder(s) are selected from the group consisting of polyester resins, epoxy resins, polyurethane resins, UV curing systems, acrylates, and mixtures thereof.

20. The method for the production of coated pearlescent pigments according to claim 19, wherein said polyester resins are selected from the group consisting of saturated OH group-containing polyester resins with a hydroxyl number between 15 and 350 mg KOH/g, saturated carboxyl group-containing polyester resins with an acid number between 25 and 120 mg KOH/g, and mixtures thereof.

21. The method for the production of coated pearlescent pigments according to claim 19, wherein said epoxy resins are selected from the group of epoxy resins containing more than one epoxy group and preferably having an epoxy equivalent weight (EEW) of 175 to 6,000.

22. The method for the production of coated pearlescent pigments according to claim 19, wherein said polyurethane resins are selected from group consisting of OH functional polyester resins or polyacrylate resins containing blocked and/or free polyisocyanates, and mixtures thereof.

23. The method for the production of coated pearlescent pigments according to claim 19, wherein said UV curing systems are compounds having monounsaturated and polyunsaturated double bonds.

24. The method for the production of a pearlescent pigment according to claim 1, wherein said pearlescent pigments coated with binder produced in step c) are additionally subjected to a size classification.

25. The method for the production of coated pearlescent pigments according to claim 1, wherein the solvent used is water, organic solvent, or aqueous organic solvent.

26. The method for the production of coated pearlescent pigments according to claim 1, wherein further additives and auxiliaries are added to said oligomeric and polymeric binder dissolved or dispersed in solvent, preferably prior to coming into contact with said pearlescent pigments.

27. The method for the production of coated pearlescent pigments according to claim 26, wherein said additives and auxiliaries comprise curing agents, photoinitiators and polymerization initiators.

28. The method for the production of coated pearlescent pigments according to claim 27, wherein said curing agent is selected from the group consisting of hydroxyalkylamine-containing compounds, glycidyl group-containing compounds, epoxy group-containing compounds, triglycidyl isocyanurates, and mixtures thereof.

29. The method for the production of coated pearlescent pigments according to claim 26, wherein said additives and auxiliaries comprise organic and inorganic colored pigments and dyes.

30. The method for the production of coated pearlescent pigments according to claim 26, wherein said additives and auxiliaries comprise other paint components arid additives, such as viscosity-reducing additives, slip agents, leveling agents, and also fillers, degassing agents, film-forming agents, flameproofing agents, adhesion promoters, light stabilizers, flatting agents, photoinitiators, polymerization inhibitors, polymerization initiators, freeradical scavengers, anticaking agents, radiation-curing reactive diluents, thermally crosslinkable reactive diluents, UV absorbers, cross-linking catalysts, waxes, and mixtures thereof.

31. The process for the production of coated pearlescent pigments according to claim 1, wherein cross-linking of the binder(s) and any curing agent present is thermally inducible.

32. The coated pearlescent pigments, wherein the coating surrounds the pearlescent pigments and comprises undercured but chemically cross-linkable oligomeric and/or polymeric binders and/or oligomeric and/or polymeric binders that are cross-linked under the action of heat, IR radiation, UV radiation and beams of electrons.

33. The coated pearlescent pigments according to claim 32, wherein the particle size d₅₀ of said coated pearlescent pigments ranges from 2 to 190 μm.

34. The coated pearlescent pigments according to claim 32, wherein the particle size d₅₀ of said coated pearlescent pigments ranges from 5 to 100 μm.

35. The coated pearlescent pigments according to claim 32, wherein said pearlescent pigments have from 20 to 85% by weight of oligomeric and polymeric binder, based on the total weight of said coated pearlescent pigments.

36. The coated pearlescent pigments according to claim 32, wherein said pearlescent pigments, prior to application of said binder-containing are primed with an additional, preferably cross-linked, layer or with several additional, preferably cross-linked, layers.

37. The coated pearlescent pigments according to claim 32, wherein said pearlescent pigments have a substrate selected from the group consisting of mica, talc, sericite, kaolin and also platelets of SiO₂, glass, graphite, Al₂O₃, and mixtures thereof.

38. The coated pearlescent pigments according to claim 37, wherein said substrates of said pearlescent pigments are coated with one or more layers selected from the group consisting of metal oxides, metal hydroxides, metal oxide hydrates, metal suboxides, metal sulfides, metal fluorides, metal chalcogenides, metal nitrides, metal sulfides, metal carbides, and mixtures thereof.

39. The coated pearlescent pigments according to claim 37, wherein said substrates of said pearlescent pigments are provided with a multilayered lamellar structure comprising layers containing or consisting of metal oxide, metal hydroxide, metal suboxide, and metal oxide hydrate.

40. The coated pearlescent pigments according to claim 38, wherein said substrates of said pearlescent pigments are coated with one or more metal oxide layers selected from the group consisting of TiO₂, Fe₂O₃, Fe₃O₄, TiFe₂O₅, ZnO, SnO₂, CoO, CO₃O₄, ZrO₂, Cr₂O₃, VO₂, V₂O₃, (SnSb)—O₂ and mixtures thereof.

41. The coated pearlescent pigments according to claim 39, wherein said multilayered lamellar structure exhibits layers containing or consisting of high and low-refractive-index metal oxide, metal hydroxide, metal suboxide, and metal oxide hydrate, preferably arranged alternately, wherein the substrate is preferably first covered by at least one high-refractive-index layer, then by at least one low-refractive-index layer and finally by at least one high-refractive-index layer.

42. The coated pearlescent pigments according to claim 41, characterized in that said high-refractive-index metal oxide is selected from the group consisting of TiO₂, Fe₂O₃, Fe₃O₄, TiFe₂O₅, ZnO, SnO₂, CoO, CO₃O₄, ZrO₂, Cr₂O₃, VO₂, V₂O₃, (SnSb)—O₂ and mixtures thereof, and that said low-refractive-index metal oxide is preferably selected from the group consisting of Si02, AI203, and mixtures thereof.

43. The coated pearlescent pigments according to claim 37, wherein said pearlescent pigments have glass flakes as the substrate and have the following layer structures:

| | | | | | |
|---|---|---|---|---|---|
| glass flakes + | TiO₂ + | SiO₂ + | TiO₂ | | |
| glass flakes + | TiO₂ + | SiO₂ + | Fe₂O₃ | | |
| glass flakes + | TiO₂ + | SiO₂ + | TiO₂ /Fe₂O₃ | | |
| glass flakes + | TiO₂ + | SiO₂ + | (Sn,Sb)O₂ | | |
| glass flakes + | (Sn,Sb)O₂ + | SiO₂ + | TiO₂ | | |
| glass flakes + | Fe₂O₃ + | SiO₂ + | (Sn,Sb)O₂ | | |
| glass flakes + | TiO₂/ | SiO₂ + | TiO₂/Fe₂O₃ | | |
| | Fe₂O₃ | | | | |
| glass flakes + | TiO₂ + | SiO₂ + | MoS₂ | | |
| glass flakes + | TiO₂ + | SiO₂ + | Cr₂O₃ | | |
| glass flakes + | Cr₂O₃ | SiO₂ + | TiO₂ | | |
| glass flakes + | Fe₂O₃ + | SiO₂ + | TiO₂ | | |
| glass flakes + | TiO₂ + | AI₂O₃ + | TiO₂ | | |
| glass flakes + | Fe₂TiO₅ + | SiO₂ + | TiO₂ | | |
| glass flakes + | TiO₂ + | SiO₂ + | Fe₂TiO₅/TiO₂ | | |
| glass flakes + | TiO₂ | SiO₂ + | TiO₂ suboxide | | |
| | suboxide + | | | | |
| glass flakes + | TiO₂ + | SiO₂ + | TiO₂ + | SiO₂ + | TiO₂ |

44. The coated pearlescent pigments according to claim 37, wherein said pearlescent pigments consist of glass platelets coated on both sides with semi-transparent metal layers.

45. The coated pearlescent pigments according to claim 44, wherein said semi-transparent metal layers are selected from the group consisting of silver, aluminum, chromium, nickel, gold, platinum, palladium, copper, zinc, and mixtures and alloys thereof.

46. The coated pearlescent pigments according to claim 37, wherein the substrates coated with one or more metal oxide layer(s) of said pearlescent pigments are additionally coated all round with at least one external protective layer of metal oxide, metal hydroxide and/or metal oxide hydrate, which metals are preferably selected from the group consisting of silicon, aluminum, cerium, manganese, zirconium, chromium, and mixtures thereof.

47. The coated pearlescent pigments according to claim 32, wherein said pearlescent pigments consist of a single platelet-type material, which material is selected from the group consisting of bismuth oxychloride, TiO₂ and Fe₂O₃.

48. The coated pearlescent pigments according to claim 32, wherein said pearlescent pigments are primed with adhesion promoters for said binder coating, preferably functionalized silanes, functionalized polymers and/or organophosphoric compounds and more preferably phosphate esters.

49. The coated pearlescent pigments according to claim 32 wherein the binder(s) are selected from the group consisting of polyester resins, epoxy resins, polyurethane resins, UV curing systems, acrylates, and mixtures thereof.

50. The coated pearlescent pigments according to claim 49, wherein said polyester resins are selected from the group consisting of saturated OH group-containing polyester resins having a hydroxyl number between 30 and 350 mg KOH/g, saturated carboxyl group-containing polyester resins having an acid number between 15 and 120 mg KOH/g, and mixtures thereof.

51. The coated pearlescent pigments according to claim 49, wherein said epoxy resins are selected from the group of epoxy resins containing more than one epoxy group and preferably having an epoxy equivalent weight (EEW) of from 175 to 6,000.

52. The coated pearlescent pigments according to claim 49, wherein said polyurethane resins are selected from the group consisting of OH-functional polyester resins or polyacrylate resins containing blocked and/or free polyisocyanates, and mixtures thereof.

53. The coated pearlescent pigments according to claim 49, wherein said UV curing systems are compounds having monounsaturated and polyunsaturated double bonds.

54. The coated pearlescent pigments according to claim 32, wherein the coating contains, in addition to binder(s), other additives and auxiliaries.

55. The coated pearlescent pigments according to claim 54, wherein said additives and auxiliaries include curing agents, photoinitiators and polymerization initiators.

56. The coated pearlescent pigments according to claim 55, wherein said curing agent is selected from the group consisting of hydroxyalkylamine-containing compounds, glycidyl group-containing compounds, epoxy group-containing compounds, triglycidyl isocyanurates, and mixtures thereof.

57. The coated pearlescent pigments according to claim 54, wherein said additives and auxiliaries include organic and inorganic colored pigments and dyes.

58. The coated pearlescent pigments according to claim 54, said additives and auxiliaries include other varnish components and additives, such as viscosity-reducing additives, slip agents, leveling agents and also fillers, degassing agents, film-forming agents, flameproofing agents, adhesion promoters, light-stabilizers, flatting agents, photo initiators, polymerization inhibitors, polymerization initiators, free-radical scavengers, anticaking agents, radiation-curing reactive diluents, thermally crosslinkable reactive diluents, UV absorbers, cross-linking catalysts, waxes, and mixtures thereof.

59. The coated pearlescent pigments according to claim 32, wherein cross-linking of the binder(s) and any curing agent present is thermally inducible.

60. The coated pearlescent pigments according to claim 32, wherein said pearlescent pigments exist in combination with a liquid phase, preferably an organic solvent, thus forming a paste.

61. A coating composition, wherein said coating composition contains coated pearlescent pigments according to claim 32.

62. The coating composition according to claim 61, wherein said coating composition has a pearlescent pigment content of from 0.5 to 15% by weight and preferably of from 1 to 12% by weight, based on the total weight of said coating composition.

63. The coating composition according to claim 62, wherein said coating composition has a pearlescent pigment content of from 2 to 15% by weight.

64. The coating composition according to claim 61, wherein said coating composition is a powder paint.

65. The coating composition according to claim 64, wherein said powder paint and the coating on said pearlescent pigments contain at least one identical binder.

66. A coated object, wherein said object is coated with pearlescent pigments according to claim 32.

67. A coated object, wherein said object is a facade element, preferably a facade tile, a window frame, a vehicle body, preferably a vehicle body of a motor vehicle, or a frame of a vehicle, preferably of a bicycle or motor bicycle.

68. The use of the pearlescent pigment according to claim 32 in paints, enamels, powder paints, printing inks, plastics materials or cosmetic formulations such as nail varnish.

69. A coated object, wherein said object is coated with pearlescent pigments according to a coating composition according to claim 61.
